(19) United States
(12) Patent Application Publication
(10) Pub. No.: US 2025/0278823 A1
(43) Pub. Date: Sep. 4, 2025

(54) IMAGE PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventor: Yuanlue Zhu, Beijing (CN)

(21) Appl. No.: 19/066,124

(22) Filed: Feb. 27, 2025

(30) Foreign Application Priority Data
Mar. 1, 2024 (CN) 202410239002.X

(51) Int. Cl. G06T 5/80; G06T 5/60

(52) U.S. Cl. CPC G06T 5/80; G06T 5/60; G06T 2207/20081; G06T 2207/20221

(57) ABSTRACT

The present disclosure relates to an image processing method and apparatus, an electronic device, and a storage medium. The method includes: inputting an original image including a deformation defect into an image restoration model to obtain first pixel value distribution information, second pixel value distribution information, and third pixel value distribution information, where a first output image includes the first pixel value distribution information used to describe pixel value distribution of the first output image in each color channel of a preset color space, the second pixel value distribution information used to describe pixel value distribution of the first output image in a transparency channel, and the third pixel value distribution information used to describe pixel value distribution of the first output image in each coordinate channel of a preset deformation field; and fusing these information to obtain a processed image.

### CROSS-REFERENCE TO RELATED APPLICATION(S)

This application claims priority to Chinese Application No. 202410239002.X filed on Mar. 1, 2024, the disclosure of which is incorporated herein by reference in its entirety.

### FIELD

The present disclosure relates to the technical field of image processing, and in particular, to an image processing method and apparatus, an electronic device, and a storage medium.

### BACKGROUND

Image processing technologies have been widely used in various fields such as daily life, information promotion, medical imaging, remote sensing monitoring, and security monitoring. With the development of technologies, a demand for image processing is increasing, especially in terms of restoration of abnormal images. An abnormal image refers to an image in which there is a deformation defect due to a device failure, an environmental factor, an inappropriate shooting angle, etc. The image including the deformation defect is required to be restored by the image processing technologies.

### SUMMARY

According to a first aspect, embodiments of the present disclosure provide an image processing method. The method includes:
obtaining an original image, where the original image includes a deformation defect;
inputting the original image into an image restoration model to obtain a first output image, where the image restoration model is used to repair the deformation defect in the original image, the first output image includes first pixel value distribution information, second pixel value distribution information, and third pixel value distribution information, the first pixel value distribution information is used to describe pixel value distribution of the first output image in each color channel of a preset color space, the second pixel value distribution information is used to describe pixel value distribution of the first output image in a transparency channel, and the third pixel value distribution information is used to describe pixel value distribution of the first output image in each coordinate channel of a preset deformation field; and
fusing the first pixel value distribution information, the second pixel value distribution information, and the third pixel value distribution information to obtain a processed image.

According to a second aspect, embodiments of the present disclosure further provide an image processing apparatus. The apparatus includes:
an obtaining module configured to obtain an original image, where the original image includes a deformation defect;
a processing module configured to input the original image into an image restoration model to obtain a first output image, where the image restoration model is used to repair the deformation defect in the original image, the first output image includes first pixel value distribution information, second pixel value distribution information, and third pixel value distribution information, the first pixel value distribution information is used to describe pixel value distribution of the first output image in each color channel of a preset color space, the second pixel value distribution information is used to describe pixel value distribution of the first output image in a transparency channel, and the third pixel value distribution information is used to describe pixel value distribution of the first output image in each coordinate channel of a preset deformation field; and
a fusion module configured to fuse the first pixel value distribution information, the second pixel value distribution information, and the third pixel value distribution information, to obtain a processed image.

According to a third aspect, the present disclosure further provides an electronic device. The electronic device includes:
one or more processors; and
a storage apparatus configured to store one or more programs, where
the one or more programs, when executed by the one or more processors, cause the one or more processors to implement the image processing method described above.

According to a fourth aspect, the present disclosure further provides a computer-readable storage medium having a computer program stored thereon, where the program, when executed by a processor, causes the image processing method described above to be implemented.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a flowchart of an image processing method according to embodiments of the present disclosure;

FIG. 2 is a diagram of a principle of an image processing method according to embodiments of the present disclosure;

FIG. 3 is a schematic diagram of a type of key points according to embodiments of the present disclosure;

FIG. 4 is a schematic diagram of another type of key points according to embodiments of the present disclosure;

FIG. 5 is a flowchart of a method for training an image restoration model according to embodiments of the present disclosure;

FIG. 6 is a diagram of a principle of training an image restoration model according to embodiments of the present disclosure;

FIG. 7 is a flowchart of a data enhancement method according to embodiments of the present disclosure;

FIG. 8 is a schematic diagram of a structure of an image processing apparatus according to embodiments of the present disclosure; and

FIG. 9 is a schematic diagram of a structure of an electronic device according to embodiments of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

As described above, image processing technologies have been widely used in various fields such as daily life, information promotion, medical imaging, remote sensing monitoring, and security monitoring. With the development of technologies, a demand for image processing is increasing, especially in terms of restoration of abnormal images. An abnormal image refers to an image in which there is a deformation defect due to a device failure, an environmental factor, an inappropriate shooting angle, etc. The image including the deformation defect is required to be restored by the image processing technologies. However, restoration of most of the abnormal images still relies on manual operation, which has low efficiency and imposes high skill requirements on a person who performs processing. Therefore, how to increase the restoration rate of the abnormal images is an urgent problem to be solved.

To solve the above technical problems or at least partially solve the above technical problems, the present disclosure provides an image processing method and apparatus, an electronic device, and a storage medium. Compared with the prior art, the technical solution provided in the embodiments of the present disclosure has the following advantages. In the technical solution provided in the embodiments of the present disclosure, the original image is input into the image restoration model to obtain the first output image, where the image restoration model is used to repair the deformation defect in the original image, the first output image includes the first pixel value distribution information, the second pixel value distribution information, and the third pixel value distribution information, the first pixel value distribution information is used to describe the pixel value distribution of the first output image in each color channel of the preset color space, the second pixel value distribution information is used to describe the pixel value distribution of the first output image in the transparency channel, and the third pixel value distribution information is used to describe the pixel value distribution of the first output image in each coordinate channel of the preset deformation field; and the first pixel value distribution information, the second pixel value distribution information, and the third pixel value distribution information are fused to obtain the processed image. In this case, in essence, a targeted texture restoration policy (that is, the second pixel value distribution information) and a targeted deformation repair policy (that is, the third pixel value distribution information) is determined for the original image by using the image restoration model, and then, the texture restoration policy and the deformation repair policy are applied to the original image to obtain the restored image. The whole restoration process can be performed without manual participation, so that the automatic restoration of the image can be implemented. Therefore, the efficiency of restoring the image is improved, and the image is optimized.

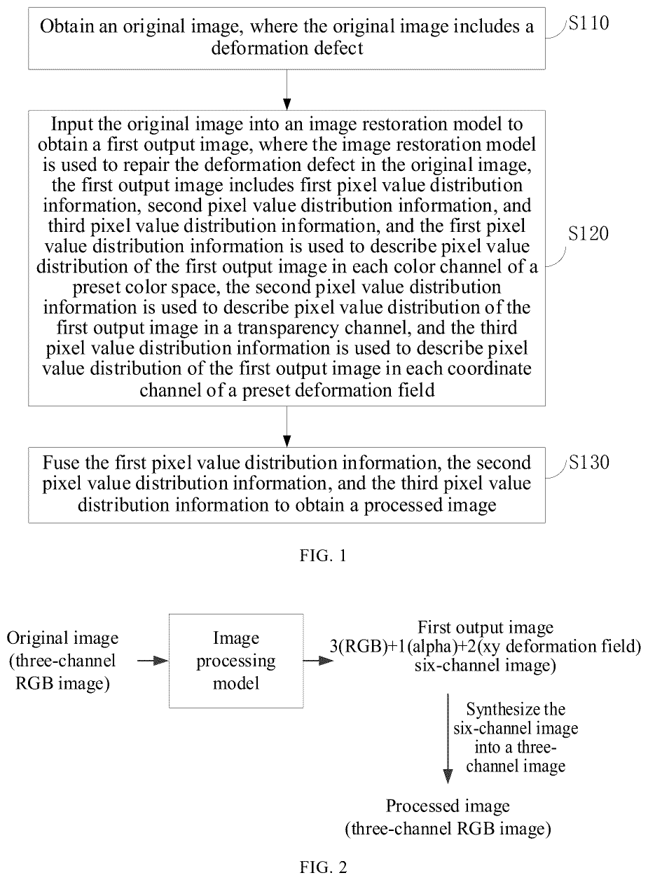

FIG. 1 is a flowchart of an image processing method according to embodiments of the present disclosure, and FIG. 2 is a diagram of a principle of an image processing method according to embodiments of the present disclosure. The embodiments are applicable to restoration of an image including a deformation defect in a client. The method may be performed by an image processing apparatus. The apparatus may be implemented in the form of software and/or hardware, and may be configured in an electronic device, for example, a terminal, specifically including, but not limited to a smartphone, a palmtop computer, a tablet computer, a wearable device with a display screen, a desktop computer, a notebook computer, an all-in-one machine, a smart home device, etc. Alternatively, the embodiments are applicable to restoration of an image including a deformation defect in a server. The method may be performed by an image processing apparatus. The apparatus may be implemented in the form of software and/or hardware, and may be configured in an electronic device, for example, a server.

As shown in FIG. 1, the method may specifically include the following steps.

S110: Obtain an original image, where the original image includes a deformation defect.

The original image may be, for example, an object that includes the deformation defect and is required to be restored. The original image may be specified by a user. Specifically, the original image may be an image shot by the user, or an image downloaded from a network. Optionally, the original image may be, for example, a static image, a dynamic image, or an image frame in a video.

The deformation defect refers to distortion, deformation, asymmetry, structural loss, or other defects in the image, which is caused by a device failure, an environmental factor, an inappropriate shooting angle, or other reasons.

It should be emphasized that, in practice, in the original image, the object in which the deformation defect occurs may specifically be a person, an animal, an object or the like.

In some scenarios, the original image is a three-channel image. For example, the original image is a color image. The color image may be considered as an image formed by pixel value distribution of various color channels. These color channels are defined in a preset color space. For example, color channels of an RGB color space include a red (R) channel, a green (G) channel, and a blue (B) channel; color channels of an HSV color space include a hue (H) channel, a saturation(S) channel, and a value (V) channel; and color channels of a YUV color space includes a Y (luminance) channel, a chrominance (U) channel, and a concentration (V) channel. The color image is a composite representation of pixel values of various color channels.

S120: Input the original image into an image restoration model to obtain a first output image, where the image restoration model is used to repair the deformation defect in the original image, the first output image includes first pixel value distribution information, second pixel value distribution information, and third pixel value distribution information, the first pixel value distribution information is used to describe pixel value distribution of the first output image in each color channel of the preset color space, the second pixel value distribution information is used to describe pixel value distribution of the first output image in a transparency channel, and the third pixel value distribution information is used to describe pixel value distribution of the first output image in each coordinate channel of a preset deformation field.

The image restoration model is a pre-trained model for repairing the deformation defect in the original image. It should be noted that in a practical application, for the repair of the deformation defect, both texture and deformation need to be considered. It is difficult to enable things in the image to appear natural and real by simply repairing deformation but ignoring texture restoration. Therefore, to achieve a better restoration effect, it is necessary to repair deformation and also restore texture, thereby ensuring the overall quality and realism of the image. Accordingly, content involved in the restoration through the image restoration model includes texture and deformation. For example, if two handles on doors in an original image have different sizes, during restoration of the original image, it is necessary to adjust positions of contour lines of the handles, and to adjust textures of the handles and the doors, so that the doors and the handles in a restored image appear natural and real. Optionally, the image restoration model may be a generative adversarial network (GAN), or another deep learning model.

The first output image is an image output by the image restoration model, and a number of channels included in this image is greater than a number of channels included in the original image. For example, the first output image is a composite representation of the first pixel value distribution information, the second pixel value distribution information, and the third pixel value distribution information.

The first pixel value distribution information reflects a color representation of the first output image. For example, the first pixel value distribution information includes pixel value distribution of the first output image in three channels, i.e., the R channel, the G channel, and the B channel. The second pixel value distribution information reflects texture details of the first output image. For example, the second pixel value distribution information includes the pixel value distribution of the first output image in the transparency channel. The third pixel value distribution information reflects a deformation representation of the first output image. For example, the deformation field is a rectangular coordinate system including an X axis and a Y axis that are perpendicular to each other. The X axis and the Y axis represent horizontal and vertical directions of the image, respectively. A degree of deformation of the image in the horizontal and vertical directions may be determined by analyzing distribution of pixel values on the X axis and the Y axis. The third pixel value distribution information includes the pixel value distribution of the first output image on the X axis and on the Y axis.

S130: Fuse the first pixel value distribution information, the second pixel value distribution information, and the third pixel value distribution information to obtain a processed image.

This step can be implemented by many methods, which is not limited in the present application. For example, an implementation method of this step may include: setting a weight for each of the first pixel value distribution information, the second pixel value distribution information, and the third pixel value distribution information, and obtaining fused pixel value distribution information, that is, the processed image by using weighted pixel values as fused pixel values.

Further, in practice, the first pixel value distribution information and the second pixel value distribution information may be fused first to obtain a first fusion result, and then the first fusion result and the third pixel value distribution information are fused to obtain the processed image. Alternatively, the first pixel value distribution information and the third pixel value distribution information are fused first to obtain a second fusion result, and then the second fusion result and the second pixel value distribution information are fused to obtain the processed image.

In the technical solution described above, the original image is input into the image restoration model to obtain the first output image, where the image restoration model is used to repair the deformation defect in the original image, the first output image includes the first pixel value distribution information, the second pixel value distribution information, and the third pixel value distribution information, the first pixel value distribution information is used to describe the pixel value distribution of the first output image in each color channel of the preset color space, the second pixel value distribution information is used to describe the pixel value distribution of the first output image in the transparency channel, and the third pixel value distribution information is used to describe the pixel value distribution of the first output image in each coordinate channel of the preset deformation field; and the first pixel value distribution information, the second pixel value distribution information, and the third pixel value distribution information are fused to obtain the processed image. In this case, in essence, a targeted texture restoration policy (that is, the second pixel value distribution information) and a targeted deformation repair policy (that is, the third pixel value distribution information) is determined for the original image by using the image restoration model, and then, the texture restoration policy and the deformation repair policy are applied to the original image to obtain the restored image. The whole restoration process can be performed without manual participation, so that the automatic restoration of the image can be implemented. Therefore, the efficiency of restoring the image is improved, and the image is optimized, for example, in the case of face lifting optimization.

On the basis of the above technical solution, there are various methods for training the image restoration model, which is not limited in the present application. In some embodiments, a method for training the image restoration model may include: obtaining a training data pair, where the training data pair includes a first sample image and a second sample image, the first sample image includes a deformation defect, the second sample image is an image obtained after the first sample image is restored, and positions of at least a portion of key points in the first sample image are different from positions of at least a portion of key points in the second sample image; and training the image restoration model by using the training data pair.

The first sample image corresponds to the original image, both are images including deformation defects. The difference is that the first sample image is used to cooperate with the second sample image for training of the image restoration model, and the original image is an object subjected to image restoration through the image restoration model after the image restoration model has been trained. The second sample image may be considered as a standard answer. The image restoration model is trained for the purpose of restoring the first sample image through the trained image restoration model to obtain a restored image that can be infinitely close to the second sample image. For example, in the first sample image, two handles on doors have different sizes. The second sample image is an image in which the defect that “two handles on doors have different sizes” in the first sample image has been restored.

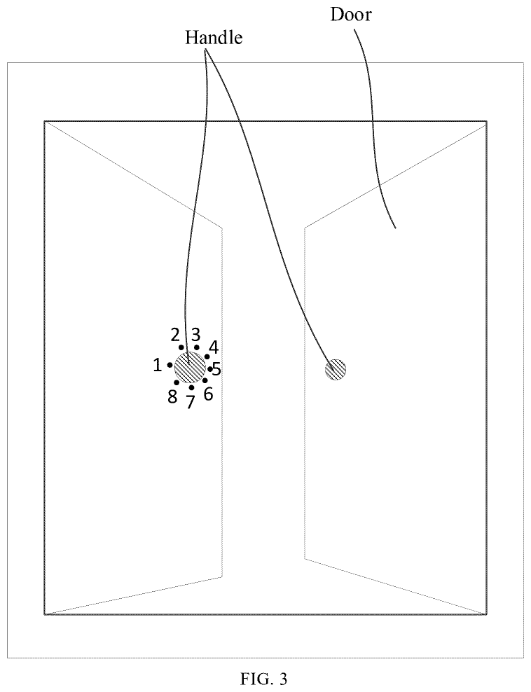

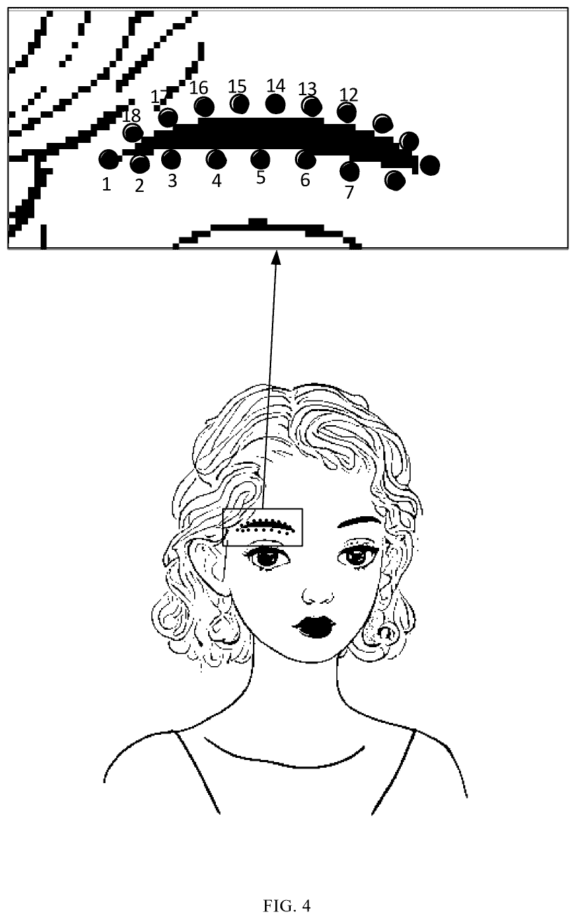

The key points are points that describe a position or contour of an object in the first sample image. The object in the first sample image is a thing in the first sample image, and the thing that the object specifically refers to is not limited in the present application. For example, the object is a person, an animal, an object, or the like, or the object is a part of a person, an animal, or an object. The positions of the key points can reflect the position or contour of the object, thereby reflecting the presence of a deformation defect in the object, and the severity of the deformation defect. FIG. 3 exemplarily shows a plurality of key points reflecting a position and/or contour of a handle on a door. FIG. 4 exemplarily shows a plurality of key points reflecting a position and/or contour of an eye. These key points are numbered by numbers for distinguishing.

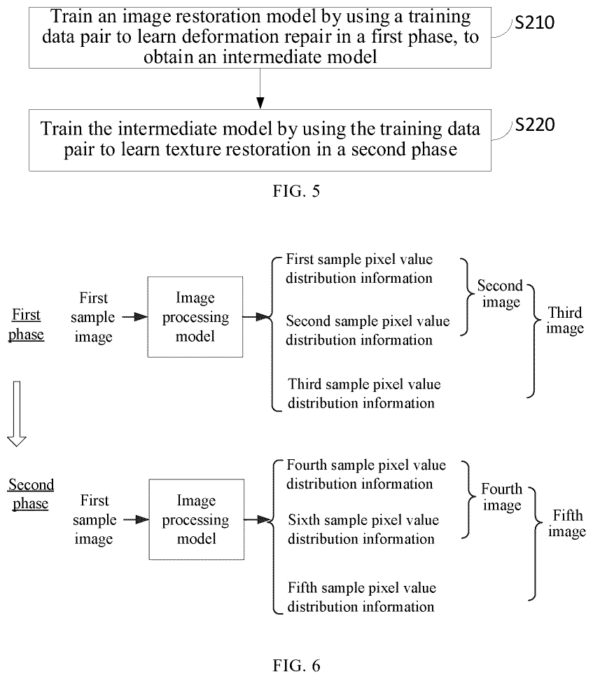

During practical training, a training process of the image restoration model can be divided into two phases, specifically, a first phase and a second phase. For example, referring to FIG. 5, training the image restoration model by using the training data pair may include:

S210: Train the image restoration model by using the training data pair to learn deformation repair in the first phase, to obtain an intermediate model.

This step can be implemented by many methods, which is not limited in the present application. For example, referring to FIG. 6, an implementation method of this step includes: inputting the first sample image of the training data pair to the image restoration model in the first phase, to obtain a second output image, where the second output image includes first sample pixel value distribution information, second sample pixel value distribution information, and third sample pixel value distribution information, the first sample pixel value distribution information is used to describe pixel value distribution of the second output image in each color channel of a preset color space, the second sample pixel value distribution information is used to describe pixel value distribution of the second output image in a transparency channel, and the third sample pixel value distribution information is used to describe pixel value distribution of the second output image in each coordinate channel of a preset deformation field; fusing the first sample pixel value distribution information and the second sample pixel value distribution information to obtain a second image; fusing the third sample pixel value distribution information and the second image to obtain a third image; obtaining a first loss function based on the second sample image and the third image; obtaining a second loss function based on a degree of realism of the third image; and adjusting a parameter of the image restoration model based on the first loss function and/or the second loss function. The fusion order of the first sample pixel value distribution information, the second sample pixel value distribution information, and the third sample pixel value distribution information in this method is determined based on a learning objective of the first phase (that is, focusing on learning deformation repair while learning texture restoration as well), to ensure that the model has a good deformation repair ability.

The second output image is an overall representation of the first sample pixel value distribution information, the second sample pixel value distribution information, and the third sample pixel value distribution information, and is data directly output by image restoration model in the first phase when the input to the image restoration model is the first sample image. For example, still referring to FIG. 6, the first sample image may be a three-channel image, and the second output image may be a six-channel image. The plurality of channels in the second output image are fused to obtain a new three-channel image (that is, the third image), where the third image is a final restoration result of the image restoration model in this phase. The purpose of training in this phase is to enable a position of a key point of an object in the third image to be similar to a position of the key point of the object in the second sample image, and texture of the object in the third image to be as similar as possible to texture of the object in the second sample image.

The first sample pixel value distribution information has a meaning similar to that of the first pixel value distribution information, with the main difference that the first sample pixel value distribution information is data output in the first phase of the training of the image restoration model, and the first pixel value distribution information is data output by the image restoration model in a process of using the trained image restoration model.

The second sample pixel value distribution information has a meaning similar to that of the second pixel value distribution information, with the main difference that the second sample pixel value distribution information is data output in the first phase of the training of the image restoration model, and the second pixel value distribution information is data output by the image restoration model in the process of using the trained image restoration model.

The third sample pixel value distribution information has a meaning similar to the third pixel value distribution information, with the main difference that the third sample pixel value distribution information is data output in the first phase of the training of the image restoration model, and the third pixel value distribution information is data output by the image restoration model in the process of using the trained image restoration model.

The first loss function reflects a difference between the second sample image and the third image. The second loss function reflects the degree of realism of the third image. Here, the degree of realism of the image refers to a similarity between a scene or an object in an image, and a real scene or object. In practice, the degree of realism of the third image may be determined based on one or more of the resolution, color accuracy, detail presentation, and texture representation of the third image.

S220: Train the intermediate model by using the training data pair to learn texture restoration in the second phase.

This step can be implemented by many methods, which is not limited in the present application. For example, referring to FIG. 6, an implementation method of this step includes: inputting the first sample image of the training data pair to the intermediate model in the second phase, to obtain a third output image, where the third output image includes fourth sample pixel value distribution information, fifth sample pixel value distribution information, and sixth sample pixel value distribution information, the fourth sample pixel value distribution information is used to describe pixel value distribution of the third output image in each color channel of a preset color space, the fifth sample pixel value distribution information is used to describe pixel value distribution of the third output image in a transparency channel, and the sixth sample pixel value distribution information is used to describe pixel value distribution of the third output image in each coordinate channel of a preset deformation field; and fusing the fourth sample pixel value distribution information and the sixth sample pixel value distribution information to obtain a fourth image; fusing the fifth sample pixel value distribution information and the fourth image to obtain a fifth image; obtaining a third loss function based on the second sample image and the fifth image; obtaining a fourth loss function based on a degree of realism of the fifth image; obtaining a fifth loss function based on the second sample image and the fourth image; and adjusting a parameter of the image restoration model based on at least one of the third loss function, the fourth loss function, and the fifth loss function. The fusion order of the fourth sample pixel value distribution information, the fifth sample pixel value distribution information, and the sixth sample pixel value distribution information in this method is determined based on a learning objective of the second phase (that is, optimizing the texture restoration ability while maintaining the learned deformation learning ability), to ensure that the model has a good texture restoration ability and a good deformation repair ability.

The third output image is an image output by the image restoration model in the second phase when the input to the image restoration model is the first sample image. For example, the first sample image may be a three-channel image, and the third output image may be a six-channel image. The plurality of channels in the third output image are fused to obtain a new three-channel image (that is, the fifth image), which is a final output image of the image restoration model in the second phase.

The fourth sample pixel value distribution information has a meaning similar to that of the first pixel value distribution information, with the only difference that the fourth sample pixel value distribution information is data output in the second phase of the training of the image restoration model, and the first pixel value distribution information is data output by the image restoration model in the process of using the trained image restoration model.

The fifth sample pixel value distribution information has a meaning similar to that of the second pixel value distribution information, with the only difference that the fifth sample pixel value distribution information is data output in the second phase of the training of the image restoration model, and the second pixel value distribution information is data output by the image restoration model in the process of using the trained image restoration model.

The sixth sample pixel value distribution information has a meaning similar to that of the third pixel value distribution information, with the only difference that the sixth sample pixel value distribution information is data output in the second phase of the training of the image restoration model, and the third pixel value distribution information is data output by the image restoration model in the process of using the trained image restoration model.

The third loss function reflects a difference between the second sample image and the fifth image. The fourth loss function reflects the degree of realism of the fifth image. Here, the degree of realism of the image refers to a similarity between a scene or an object in an image, and a real scene or object. In practice, the degree of realism of the fifth image is determined based on one or more of the resolution, color accuracy, detail presentation, and texture representation of the fifth image. The fifth loss function reflects a difference between the second sample image and the fourth image.

It should be noted that in the first phase, the image restoration model learns both deformation repair and texture restoration, but the focus of learning is on deformation repair. In an actual restoration process, the deformation repair may introduce a new obvious texture defect to the image. Here, the “new obvious texture defect” is caused by the deformation repair, rather than originally existing in the image to be restored. If the second-phase learning is not performed, the texture defect caused by the deformation repair would remain in the restored image. Accordingly, the second-phase learning is provided. Therefore, the objective of the second-phase learning is to optimize the texture restoration ability and maintain the learned deformation learning ability.

It should also be noted that if the second-phase learning is directly performed without the first-phase learning, the image processing model is easy to be lazy, which eventually leads to the failure in learning the deformation repair ability or the poor deformation repair ability.

In practice, the training data pair used in the first phase and the training data pair used in the second phase may be completely the same, partially the same, or completely different.

On the basis of the above technical solutions, optionally, a number of training data pairs used in the first phase is greater than a number of training data pairs used in the second phase. The reason for this is that the more the training data pairs are used in the first phase, the more obvious the new texture defect introduced in the image restoration process is. The introduction of the new texture defect can be effectively avoided by setting the number of the training data pairs used in the first phase to be greater than the number of the training data pairs used in the second phase.

In some embodiments, optionally, a weight of the first sample pixel value distribution information when pixel values of the plurality of channels are fused in the first phase and a weight of the fourth sample pixel value distribution information when pixel values of the plurality of channels are fused in the second phase may be the same or different, which is not limited in the present application. Similarly, a weight of the second sample pixel value distribution information when pixel values of the plurality of channels are fused in the first phase and a weight of the fifth sample pixel value distribution information when pixel values of the plurality of channels are fused in the second phase may be the same or different, which is not limited in the present application. A weight of the third sample pixel value distribution information when pixel values of the plurality of channels are fused in the first phase and a weight of the sixth sample pixel value distribution information when pixel values of the plurality of channels are fused in the second phase may be the same or different, which is not limited in the present application.

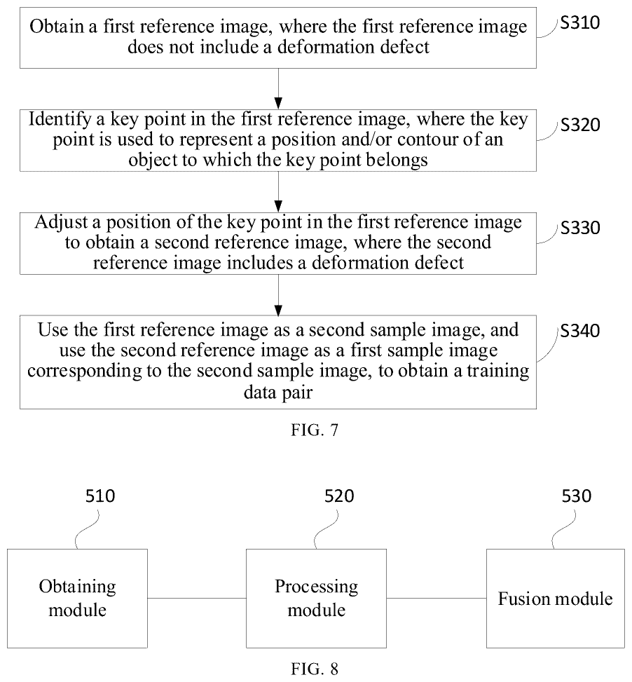

Considering that there is less data that can serve as the training data pair in practice, data enhancement may be performed based on existing data. Specifically, referring to FIG. 7, a data enhancement process may include:

S310: Obtain a first reference image, where the first reference image does not include a deformation defect.

The first reference image is a basis of data enhancement, and is a normal image, that is, an image that does not have a deformation defect, and thus does not require deformation repair.

S320: Identify a key point in the first reference image, where the key point is used to characterize a position and/or contour of an object to which the key point belongs.

The key point is a point that describes a position or contour of an object in the first reference image. The object in the first reference image is a thing in the first reference image, and the thing that the object specifically refers to is not limited in the present application. For example, the object is a person, an animal, an object, or the like, or the object is a part of a person, an animal, or an object.

S330: Adjust a position of the key point in the first reference image to obtain a second reference image, where the second reference image includes a deformation defect.

The second reference image may, for example, be an adjustment result obtained after the position of the key point of the object in the first reference image is adjusted. The purpose of adjusting the position of the key point in this step is to enable the image without a defect (that is, the first reference image) to become an image with a defect (that is, the second reference image).

In practice, if the first reference image includes a plurality of key points, when this step is performed, the adjustment may be performed on only positions of some of the key points, or on positions of all of the key points. For example, the first reference image includes two doors, and each door has a handle. In practice, adjustment may be performed on only positions of all key points of the handles, on positions of all key points of the doors and handles, or on only positions of key points of a left door and a handle on the left door.

S340: Obtain a training data pair by using the first reference image as a second sample image, and using the second reference image as a first sample image corresponding to the second sample image.

Since the first reference image corresponds to the second reference image, with the only difference that the first reference image does not include a deformation defect and the second reference image includes a deformation defect, the first reference image may be used as the second sample image, and the second reference image may be used as the first sample image, thereby forming the training data pair. In this way, the purpose of data enhancement is achieved.

With the above method, the key point in the first reference image is identified, where the key point is used to characterize the position and/or contour of the object to which the key point belongs; the position of the key point in the first reference image is adjusted to obtain the second reference image, where the second reference image includes the deformation defect; and the training data pair may be obtained by using the first reference image as the second sample image, and using the second reference image as the first sample image corresponding to the second sample image. In this way, a data enhancement method is provided, so that the problem of a poor training effect on the image restoration model due to less data that can serve as the training data pair may be solved.

Optionally, S330 may include: determining a target amplitude of position adjustment of the key point based on identification information of the key point; and adjusting the position of the key point in the first reference image based on the target amplitude of position adjustment of the key point, to obtain the second reference image.

The target amplitude of position adjustment of the key point describes a relative position relationship between positions of a same key point in the second reference image and in the first reference image.

Optionally, determining the target amplitude of position adjustment of the key point based on the identification information of the key point may include: determining a basic amplitude of position adjustment of the key point based on the identification information of the key point; and determining the target amplitude of position adjustment of the key point based on the basic amplitude of position adjustment of the key point.

The identification information of the key point may be, for example, information for distinguishing one key point from other key points. For example, the identification information of the key point may be a serial number of the key point.

For example, referring to FIG. 3 or FIG. 4, different key points have different serial numbers, and a correspondence between a serial number of a key point and a basic amplitude of position adjustment of the key point is established in advance. If it is desired to adjust positions of key points with serial numbers 3, 4, and 5 in the first reference image, basic amplitude of position adjustments respectively corresponding to the key points with the serial numbers 3, 4, and 5 are looked up to obtain target amplitude of position adjustment respectively corresponding to the key points with the serial numbers 3, 4, and 5.

Further, in practice, determining the target amplitude of position adjustment of the key point based on the basic amplitude of position adjustment of the key point may include: determining the target amplitude of position adjustment of the key point based on the basic amplitude of position adjustment of the key point, and a preset disturbance quantity.

The preset disturbance quantity may be, for example, a value taken randomly within a preset value range. The specific setting of the preset value range is not limited in the present application. For example, the preset value range is (0, 2).

Optionally, the target amplitude of position adjustment of the key point is set to be equal to a product or sum of the basic amplitude of position adjustment of the key point, and the preset disturbance quantity.

The reason for determining the target amplitude of position adjustment of the key point based on the identification information of the key point is that although a device failure, an environmental factor, an inappropriate shooting angle, etc. may cause an image to have a deformation defect, a severity (represented by a degree of deviation of the position of the key point) of the defect is limited, rather than the position of the key point being able to infinitely deviate. Such a setting enables the image including the deformation defect (that is, the second reference image) to be closer to a real shot photograph. In addition, arbitrarily adjustment of the position of the key point in the first reference image may cause a failure in triangulation, resulting in a black hole which cannot be repaired.

Further, before determining the basic amplitude of position adjustment of the key point based on the identification information of the key point, the method further includes: obtaining a sixth image and a seventh image, where the sixth image includes a deformation defect, and the seventh image is an image obtained after the sixth image is restored; determining the basic amplitude of position adjustment of the key point based on positions of a same key point in the sixth image and in the seventh image; and establishing a correspondence between the identification information of the key point and the basic amplitude of position adjustment of the key point.

The sixth image is a real image which is required to be restored and includes the deformation defect, and the seventh image is an image obtained after the deformation defect in the sixth image is restored. In some scenarios, the sixth image is a real shot image.

For example, the sixth image and the seventh image each includes a handle on a door; and a position of a key point a in the sixth image is A1, and a position of the key point in the seventh image is A2. A2-A1 is a basic amplitude of position adjustment corresponding to the key point a.

The basic amplitude of position adjustment of the key point is determined based on the positions of the same key point in the sixth image and in the seventh image; and the correspondence between the identification information of the key point and the basic amplitude of position adjustment of the key point is established. In this case, in essence, the determination of a correspondence between a category of an object to which the key point belongs and the basic amplitude of position adjustment of the key point is on the basis of a real abnormal image, thereby enabling the deformation defect included in the second reference image reasonable.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It should be noted that for ease of description, the foregoing method embodiments are described as a series of action combinations. However, those skilled in the art should understand that the present invention is not limited to the order of actions described, because some steps may be performed in another order or simultaneously according to the present invention. Moreover, those skilled in the art should also understand that the embodiments described in this specification are all preferred embodiments, and the involved actions and modules are not necessarily required in the present invention.

FIG. 8 is a schematic diagram of a structure of an image processing apparatus according to embodiments of the present disclosure. The image processing apparatus provided in these embodiments of the present disclosure may be configured in a client, or in a server. Referring to FIG. 8, the image processing apparatus specifically includes:
an obtaining module 510 configured to obtain an original image, where the original image includes a deformation defect;
a processing module 520 configured to input the original image into an image restoration model to obtain a first output image, where the image restoration model is used to repair the deformation defect in the original image, the first output image includes first pixel value distribution information, second pixel value distribution information, and third pixel value distribution information, the first pixel value distribution information is used to describe pixel value distribution of the first output image in each color channel of a preset color space, the second pixel value distribution information is used to describe pixel value distribution of the first output image in a transparency channel, and the third pixel value distribution information is used to describe pixel value distribution of the first output image in each coordinate channel of a preset deformation field; and
a fusion module 530 configured to fuse the first pixel value distribution information, the second pixel value distribution information, and the third pixel value distribution information to obtain a processed image.

Further, the apparatus further includes a training module. The training module is configured to:
obtain a training data pair, where the training data pair includes a first sample image and a second sample image, the first sample image includes a deformation defect, the second sample image is an image obtained after the first sample image is restored, and positions of at least a portion of key points in the first sample image are different from positions of at least a portion of key points in the second sample image; and
train the image restoration model by using the training data pair.

Further, a training process of the image restoration model includes a first phase and a second phase; and
the training module is configured to:
train the image restoration model by using the training data pair to learn deformation repair in the first phase, to obtain an intermediate model; and
train the intermediate model by using the training data pair to learn texture restoration in the second phase.

Further, the training module is configured to:
input the first sample image of the training data pair to the image restoration model in the first phase, to obtain a second output image, where the second output image includes first sample pixel value distribution information, second sample pixel value distribution information, and third sample pixel value distribution information, the first sample pixel value distribution information is used to describe pixel value distribution of the second output image in each color channel of a preset color space, the second sample pixel value distribution information is used to describe pixel value distribution of the second output image in a transparency channel, and the third sample pixel value distribution information is used to describe pixel value distribution of the second output image in each coordinate channel of a preset deformation field;
fuse the first sample pixel value distribution information and the second sample pixel value distribution information to obtain a second image;
fuse the third sample pixel value distribution information and the second image to obtain a third image;
obtain a first loss function based on the second sample image and the third image;
obtain a second loss function based on a degree of realism of the third image; and
adjust a parameter of the image restoration model based on the first loss function and/or the second loss function.

Further, the training module is configured to:
input the first sample image of the training data pair to the intermediate model in the second phase, to obtain a third output image, where the third output image includes fourth sample pixel value distribution information, fifth sample pixel value distribution information, and sixth sample pixel value distribution information, the fourth sample pixel value distribution information is used to describe pixel value distribution of the third output image in each color channel of a preset color space, the fifth sample pixel value distribution information is used to describe pixel value distribution of the third output image in a transparency channel, and the sixth sample pixel value distribution information is used to describe pixel value distribution of the third output image in each coordinate channel of a preset deformation field; and
fuse the fourth sample pixel value distribution information and the sixth sample pixel value distribution information to obtain a fourth image;
fuse the fifth sample pixel value distribution information and the fourth image to obtain a fifth image;
obtain a third loss function based on the second sample image and the fifth image;
obtain a fourth loss function based on a degree of realism of the fifth image;
obtain a fifth loss function based on the second sample image and the fourth image; and
adjust a parameter of the image restoration model based on at least one of the third loss function, the fourth loss function, and the fifth loss function.

Further, a number of training data pairs used in the first phase is greater than a number of training data pairs used in the second phase.

Further, the apparatus further includes a data enhancement module. The data enhancement module is configured to:
obtain a first reference image, where the first reference image does not include a deformation defect;
identify a key point in the first reference image, where the key point is used to characterize a position and/or contour of an object to which the key point belongs;
adjust a position of the key point in the first reference image to obtain a second reference image, where the second reference image includes a deformation defect; and
obtain the training data pair by using the first reference image as the second sample image, and using the second reference image as the first sample image corresponding to the second sample image.

Further, the data enhancement module is configured to:
determine a target amplitude of position adjustment of the key point based on identification information of the key point; and
adjust the position of the key point in the first reference image based on the target amplitude of position adjustment of the key point, to obtain the second reference image.

Further, the data enhancement module is configured to:
determine a basic amplitude of position adjustment of the key point based on the identification information of the key point; and
determine the target amplitude of position adjustment of the key point based on the basic amplitude of position adjustment of the key point.

Further, the data enhancement module is configured to:
before determining the basic amplitude of position adjustment of the key point based on the identification information of the key point, obtain a sixth image and a seventh image, where the sixth image includes a deformation defect, and the seventh image is an image obtained after the sixth image is restored;
determine the basic amplitude of position adjustment of the key point based on positions of a same key point in the sixth image and in the seventh image; and
establish a correspondence between the identification information of the key point and the basic amplitude of position adjustment of the key point.

The image processing apparatus provided in the embodiments of the present disclosure can perform the steps of the image processing method provided in the method embodiments of the present disclosure, which are performed by the client or the server, and has execution steps and beneficial effects. Details are not described herein again.

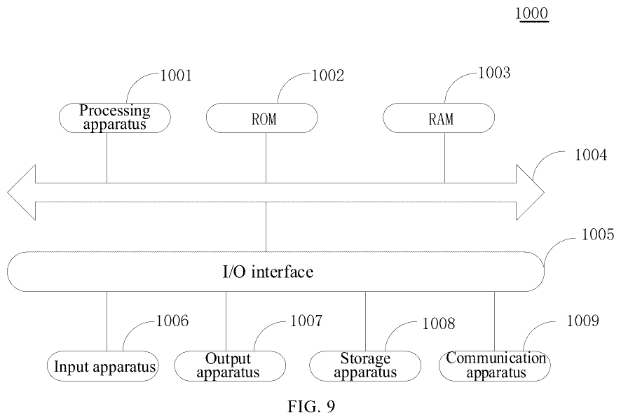

FIG. 9 is a schematic diagram of a structure of an electronic device according to embodiments of the present disclosure. Reference is made specifically to FIG. 9 below, which is a schematic diagram of a structure of an electronic device 1000 suitable for implementing the embodiments of the present disclosure. The electronic device 1000 in these embodiments of the present disclosure may include, but is not limited to, a mobile terminal such as a mobile phone, a notebook computer, a digital broadcast receiver, a personal digital assistant (PDA), a tablet computer (PAD), a portable multimedia player (PMP), a vehicle-mounted terminal (such as a vehicle navigation terminal), and a wearable electronic device, and a fixed terminal such as a digital TV, a desktop computer, and a smart home device. The electronic device shown in FIG. 9 is merely an example, and shall not impose any limitation on the function and scope of use of the embodiments of the present disclosure.

As shown in FIG. 9, the electronic device 1000 may include a processing apparatus (such as a central processing unit or a graphics processing unit) 1001 that may perform a variety of appropriate actions and processing in accordance with a program stored in a read-only memory (ROM) 1002 or a program loaded from a storage apparatus 1008 into a random access memory (RAM) 1003 to implement the image processing method according to the embodiments of the present disclosure. The RAM 1003 further stores various programs and information required for the operation of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touchscreen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a tape and a hard disk; and a communication apparatus 1009. The communication apparatus 1009 may allow the electronic device 1000 to perform wireless or wired communication with other devices to exchange information. Although FIG. 9 shows the electronic device 1000 having various apparatuses, it should be understood that it is not required to implement or have all of the shown apparatuses. It may be an alternative to implement or have more or fewer apparatuses.

In particular, according to embodiments of the present disclosure, the process described above with reference to the flowchart may be implemented as a computer software program. For example, these embodiments of the present disclosure include a computer program product, which includes a computer program carried on a non-transitory computer-readable medium, where the computer program includes program code for performing the method shown in the flowchart, to implement the above image processing method described above. In such an embodiment, the computer program may be downloaded from a network through the communication apparatus 1009 and installed, installed from the storage apparatus 1008, or installed from the ROM 1002. When the computer program is executed by the processing apparatus 1001, the above-mentioned functions defined in the method of the embodiments of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include an information signal propagated in a baseband or as a part of a carrier, in which a computer-readable program code is carried. The propagated information signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any known or future-developed network protocol such as a Hypertext Transfer Protocol (HTTP), and may be connected to digital information communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any known or future-developed network.

The above computer-readable medium may be contained in the above electronic device. Alternatively, the computer-readable medium may exist independently, without being assembled into the electronic device.

The above computer-readable medium carries one or more programs. The one or more programs, when being executed by the electronic device, cause the electronic device to:
obtain an original image, where the original image includes a deformation defect;
input the original image to an image restoration model into obtain a first output image, where the image restoration model is used to repair the deformation defect in the original image, the first output image includes first pixel value distribution information, second pixel value distribution information, and third pixel value distribution information, the first pixel value distribution information is used to describe pixel value distribution of the first output image in each color channel of a preset color space, the second pixel value distribution information is used to describe pixel value distribution of the first output image in a transparency channel, and the third pixel value distribution information is used to describe pixel value distribution of the first output image in each coordinate channel of a preset deformation field; and
fuse the first pixel value distribution information, the second pixel value distribution information, and the third pixel value distribution information to obtain a processed image.

Optionally, when the one or more programs are executed by the electronic device, the electronic device may also perform other steps of the above embodiments.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, the present disclosure provides an electronic device. The electronic device includes:
one or more processors; and
a memory configured to store one or more programs, where
the one or more programs, when executed by the one or more processors, cause the one or more processors to implement any of the image processing methods provided in the present disclosure.

According to one or more embodiments of the present disclosure, the present disclosure provides a computer-readable storage medium having a computer program stored thereon, where the program, when executed by a processor, causes any of the image processing methods provided in the present disclosure to be implemented.

Embodiments of the present disclosure further provide a computer program product, including a computer program or instruction that, when executed by a processor, causes the image processing method described above to be implemented.

It should be noted that the relational terms such as “first” and “second” herein are only used to distinguish one entity or operation from another, and do not necessarily require or imply that any actual relationship or sequence exists between these entities or operations. Moreover, the terms “include”, “comprise”, or their any other variants are intended to cover a non-exclusive inclusion, so that a process, a method, an article, or a device that includes a list of elements not only includes those elements but also includes other elements which are not expressly listed, or further includes elements inherent to such process, method, article, or device. In the absence of more restrictions, an element defined by “including a . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to a person skilled in the art, and the general principle defined herein may be practiced in other embodiments without departing from the spirit or scope of the present disclosure. Therefore, the present disclosure is not limited to the embodiments herein but is to be accorded the broadest scope consistent with the principle and novel features disclosed herein.

I/we claim:

1. An image processing method, comprising:
obtaining an original image, the original image comprising a deformation defect;
inputting the original image into an image restoration model, to obtain a first output image, the image restoration model being used to repair the deformation defect in the original image, the first output image comprising first pixel value distribution information, second pixel value distribution information, and third pixel value distribution information, the first pixel value distribution information being used to describe pixel value distribution of the first output image in each color channel of a preset color space, the second pixel value distribution information being used to describe pixel value distribution of the first output image in a transparency channel, and the third pixel value distribution information being used to describe pixel value distribution of the first output image in each coordinate channel of a preset deformation field; and
fusing the first pixel value distribution information, the second pixel value distribution information, and the third pixel value distribution information, to obtain a processed image.

2. The method according to claim 1, wherein training the image restoration model comprises:
obtaining a training data pair, the training data pair comprising a first sample image and a second sample image, the first sample image comprising a deformation defect, the second sample image being an image obtained after the first sample image is restored, and positions of at least a portion of key points in the first sample image being different from positions of at least a portion of key points in the second sample image; and
training the image restoration model by using the training data pair.

3. The method according to claim 2, wherein a training process of the image restoration model comprises a first phase and a second phase, and training the image restoration model by using the training data pair comprises:
training the image restoration model by using the training data pair to learn deformation repair in the first phase, to obtain an intermediate model; and
training the intermediate model by using the training data pair to learn texture restoration in the second phase.

4. The method according to claim 3, wherein training the image restoration model by using the training data pair to learn deformation repair in the first phase comprises:
inputting the first sample image of the training data pair into the image restoration model in the first phase, to obtain a second output image, the second output image comprising first sample pixel value distribution information, second sample pixel value distribution information, and third sample pixel value distribution information, the first sample pixel value distribution information being used to describe pixel value distribution of the second output image in each color channel of a preset color space, the second sample pixel value distribution information being used to describe pixel value distribution of the second output image in a transparency channel, and the third sample pixel value distribution information being used to describe pixel value distribution of the second output image in each coordinate channel of a preset deformation field;
fusing the first sample pixel value distribution information and the second sample pixel value distribution information, to obtain a second image;
fusing the third sample pixel value distribution information and the second image, to obtain a third image;
obtaining a first loss function based on the second sample image and the third image;
obtaining a second loss function based on a degree of realism of the third image; and
adjusting a parameter of the image restoration model based on the first loss function and/or the second loss function.

5. The method according to claim 3, wherein training the intermediate model by using the training data pair to learn texture restoration in the second phase comprises:
inputting a first sample image of the training data pair into the intermediate model in the second phase, to obtain a third output image, the third output image comprising fourth sample pixel value distribution information, fifth sample pixel value distribution information, and sixth sample pixel value distribution information, the fourth sample pixel value distribution information being used to describe pixel value distribution of the third output image in each color channel of a preset color space, the fifth sample pixel value distribution information being used to describe pixel value distribution of the third output image in a transparency channel, and the sixth sample pixel value distribution information being used to describe pixel value distribution of the third output image in each coordinate channel of a preset deformation field; and
fusing the fourth sample pixel value distribution information and the sixth sample pixel value distribution information, to obtain a fourth image;
fusing the fifth sample pixel value distribution information and the fourth image, to obtain a fifth image;
obtaining a third loss function based on the second sample image and the fifth image;
obtaining a fourth loss function based on a degree of realism of the fifth image;
obtaining a fifth loss function based on the second sample image and the fourth image; and
adjusting a parameter of the image restoration model based on at least one of the third loss function, the fourth loss function, and the fifth loss function.

6. The method according to claim 3, wherein
a number of training data pairs used in the first phase is greater than a number of training data pairs used in the second phase.

7. The method according to claim 2, further comprising:
obtaining a first reference image, the first reference image not comprising a deformation defect;
identifying a key point in the first reference image, the key point being used to characterize a position and/or contour of an object to which the key point belongs;
adjusting a position of the key point in the first reference image, to obtain a second reference image, the second reference image comprising a deformation defect; and
obtaining the training data pair by using the first reference image as the second sample image, and using the second reference image as the first sample image corresponding to the second sample image.

8. The method according to claim 7, wherein adjusting the position of the key point in the first reference image, to obtain the second reference image comprises:
determining a target amplitude of position adjustment of the key point based on identification information of the key point; and
adjusting the position of the key point in the first reference image based on the target amplitude of position adjustment of the key point, to obtain the second reference image.

9. The method according to claim 8, wherein determining the target amplitude of position adjustment of the key point based on the identification information of the key point comprises:
determining a basic amplitude of position adjustment of the key point based on the identification information of the key point; and
determining the target amplitude of position adjustment of the key point based on the basic amplitude of position adjustment of the key point.

10. The method according to claim 9, wherein before determining the basic amplitude of position adjustment of the key point based on the identification information of the key point, the method further comprises:
obtaining a sixth image and a seventh image, the sixth image comprising a deformation defect, and the seventh image is an image obtained after the sixth image is restored;
determining the basic amplitude of position adjustment of the key point based on positions of a same key point in the sixth image and in the seventh image; and
establishing a correspondence between the identification information of the key point and the basic amplitude of position adjustment of the key point.

11. An electronic device, comprising:
one or more processors; and
a storage apparatus configured to store one or more programs, wherein
the one or more programs, when executed by the one or more processors, cause the one or more processors to:
obtain an original image, the original image comprising a deformation defect;
input the original image into an image restoration model, to obtain a first output image, the image restoration model being used to repair the deformation defect in the original image, the first output image comprising first pixel value distribution information, second pixel value distribution information, and third pixel value distribution information, the first pixel value distribution information being used to describe pixel value distribution of the first output image in each color channel of a preset color space, the second pixel value distribution information being used to describe pixel value distribution of the first output image in a transparency channel, and the third pixel value distribution information being used to describe pixel value distribution of the first output image in each coordinate channel of a preset deformation field; and
fuse the first pixel value distribution information, the second pixel value distribution information, and the third pixel value distribution information, to obtain a processed image.

12. The electronic device according to claim 11, wherein the one or more programs further cause the one or more processors to:
obtain a training data pair, the training data pair comprising a first sample image and a second sample image, the first sample image comprising a deformation defect, the second sample image being an image obtained after the first sample image is restored, and positions of at least a portion of key points in the first sample image being different from positions of at least a portion of key points in the second sample image; and
train the image restoration model by using the training data pair.

13. The electronic device according to claim 12, wherein a training process of the image restoration model comprises a first phase and a second phase, and the one or more programs causing the one or more processors to train the image restoration model by using the training data pair further cause the one or more processors to:
train the image restoration model by using the training data pair to learn deformation repair in the first phase, to obtain an intermediate model; and
train the intermediate model by using the training data pair to learn texture restoration in the second phase.

14. The electronic device according to claim 13, wherein the one or more programs causing the one or more processors to train the image restoration model by using the training data pair to learn deformation repair in the first phase further cause the one or more processors to:
input the first sample image of the training data pair into the image restoration model in the first phase, to obtain a second output image, the second output image comprising first sample pixel value distribution information, second sample pixel value distribution information, and third sample pixel value distribution information, the first sample pixel value distribution information being used to describe pixel value distribution of the second output image in each color channel of a preset color space, the second sample pixel value distribution information being used to describe pixel value distribution of the second output image in a transparency channel, and the third sample pixel value distribution information being used to describe pixel value distribution of the second output image in each coordinate channel of a preset deformation field;
fuse the first sample pixel value distribution information and the second sample pixel value distribution information, to obtain a second image;
fuse the third sample pixel value distribution information and the second image, to obtain a third image;
obtain a first loss function based on the second sample image and the third image;
obtain a second loss function based on a degree of realism of the third image; and
adjust a parameter of the image restoration model based on the first loss function and/or the second loss function.

15. The electronic device according to claim 13, wherein the one or more programs causing the one or more processors to train the intermediate model by using the training data pair to learn texture restoration in the second phase further cause the one or more processors to:
input a first sample image of the training data pair into the intermediate model in the second phase, to obtain a third output image, the third output image comprising fourth sample pixel value distribution information, fifth sample pixel value distribution information, and sixth sample pixel value distribution information, the fourth sample pixel value distribution information being used to describe pixel value distribution of the third output image in each color channel of a preset color space, the fifth sample pixel value distribution information being used to describe pixel value distribution of the third output image in a transparency channel, and the sixth sample pixel value distribution information being used to describe pixel value distribution of the third output image in each coordinate channel of a preset deformation field; and
fuse the fourth sample pixel value distribution information and the sixth sample pixel value distribution information, to obtain a fourth image;
fuse the fifth sample pixel value distribution information and the fourth image, to obtain a fifth image;
obtain a third loss function based on the second sample image and the fifth image;
obtain a fourth loss function based on a degree of realism of the fifth image;
obtain a fifth loss function based on the second sample image and the fourth image; and
adjust a parameter of the image restoration model based on at least one of the third loss function, the fourth loss function, and the fifth loss function.

16. The electronic device according to claim 13, wherein
a number of training data pairs used in the first phase is greater than a number of training data pairs used in the second phase.

17. The electronic device according to claim 12, the one or more programs further cause the one or more processors to:
obtain a first reference image, the first reference image not comprising a deformation defect;
identify a key point in the first reference image, the key point being used to characterize a position and/or contour of an object to which the key point belongs;
adjust a position of the key point in the first reference image, to obtain a second reference image, the second reference image comprising a deformation defect; and
obtain the training data pair by using the first reference image as the second sample image, and using the second reference image as the first sample image corresponding to the second sample image.

18. The electronic device according to claim 17, wherein the one or more programs causing the one or more processors to adjust the position of the key point in the first reference image, to obtain the second reference image further cause the one or more processors to:
determine a target amplitude of position adjustment of the key point based on identification information of the key point; and
adjust the position of the key point in the first reference image based on the target amplitude of position adjustment of the key point, to obtain the second reference image.

19. The electronic device according to claim 18, wherein the one or more programs causing the one or more processors to determine the target amplitude of position adjustment of the key point based on the identification information of the key point further cause the one or more processors to:
determine a basic amplitude of position adjustment of the key point based on the identification information of the key point; and
determine the target amplitude of position adjustment of the key point based on the basic amplitude of position adjustment of the key point.

20. A non-transitory computer-readable storage medium having a computer program stored thereon, wherein the program, when executed by a processor, causes the processor to:
obtain an original image, the original image comprising a deformation defect;
input the original image into an image restoration model, to obtain a first output image, the image restoration model being used to repair the deformation defect in the original image, the first output image comprising first pixel value distribution information, second pixel value distribution information, and third pixel value distribution information, the first pixel value distribution information being used to describe pixel value distribution of the first output image in each color channel of a preset color space, the second pixel value distribution information being used to describe pixel value distribution of the first output image in a transparency channel, and the third pixel value distribution information being used to describe pixel value distribution of the first output image in each coordinate channel of a preset deformation field; and
fuse the first pixel value distribution information, the second pixel value distribution information, and the third pixel value distribution information, to obtain a processed image.
